(19) United States
(12) Patent Application Publication
(10) Pub. No.: US 2013/0218584 A1
(43) Pub. Date: Aug. 22, 2013

(54) Method and System for Automatically Tracking and Enforcing Compliance and Version Control of regulatory training for Clinical Trials

(71) Applicants: Alden Meier, Woodland Hills, CA (US); Gabriel Kwok, Redondo Beach, CA (US); Ed Sahakian, Glendale, CA (US)

(72) Inventors: Alden Meier, Woodland Hills, CA (US); Gabriel Kwok, Redondo Beach, CA (US); Ed Sahakian, Glendale, CA (US)

(21) Appl. No.: 13/757,830

(22) Filed: Feb. 3, 2013

Related U.S. Application Data
(60) Provisional application No. 61/595,613, filed on Feb. 6, 2012.

(51) Int. Cl. G06Q 30/00; G06Q 50/22

(52) U.S. Cl. CPC G06Q 30/018; G06Q 50/22
USPC 705/2

(57) ABSTRACT

The invention provides a system that manages version changes of regulatory training and update training plans for those users who are affected by the change based on a set of rules defined by the clinical trial sponsor. The system also provides custom updated training plans when different sponsors have different rules affecting regulatory training updates.

### RELATED APPLICATIONS

This application is related to U.S. provisional application 61/595,613, filed Feb. 6, 2012, and the entirety of said application is incorporated by reference as if fully set forth herein. This application is also related to U.S. provisional application 61/595,378 filed Feb. 6, 2012, and the entirety of said provisional application is incorporated by reference as if fully set forth herein. This application is also related to U.S. provisional application 61/654,915, filed Jun. 3, 2012, the entirety of which is incorporated by reference as if fully set forth herein. This application is also related to U.S. patent application Ser. Nos. 12/452,363; 12/449,791; 13/622,519, the entirety of each of which is incorporated by reference as if fully set forth herein.

### FIELD OF USE

The invention is useful in the field of clinical trial management, and more specifically in the field of clinical trial physician and staff training record management in support of clinical trials.

### BACKGROUND

Clinical trial sponsors (Sponsors) commonly make available to clinical trial participating physicians or staff personnel (Users) online training in regulatory subjects, referred to herein as “regulatory training”. Regulatory subjects typically includes subjects such as Good Clinical Practice, Serious Adverse Events, Informed Consent Process, Product Complaint Procedure, Privacy, and other topics that are foundational to the conduct of clinical trials and are the same across all trials. A Sponsor typically maintains versions of these regulatory training subjects. Users are required to periodically update their regulatory training at scheduled intervals.

Online training systems also commonly provide a standard library of regulatory training modules. For a given clinical trial, an online training system tracks User completion of these modules and the version number of the module completed. Such online training systems typically provide for cross-trial credit for these regulatory training topics. When the User training credential “expires”, the User must repeat the regulatory training module to obtain current certification.

From time to time, changes are promulgated in regulatory subjects and consequently, changes are introduced into regulatory subject training The clinical trial Sponsor is responsible for updating regulatory training and will release updates to the regulatory training modules at various intervals. Some of the updates are minor changes which are considered to be “equivalent” to the old training with some improvements, and re-training is not required of Users with unexpired training credentials. However, some of the updates are major changes which require retraining of physicians and site support personnel, and re-training must be completed by those who are currently involved in a clinical trial or who are about to participate in a clinical trial.

Currently, there is no method for implementing version changes in a way that is consistent across the organization and are applied automatically to users at the time of the version release. Sponsors of clinical trials require some method for automatically managing the release of updates for regulatory training Each sponsor may have different requirements when updates are released and minor and major releases may also be handled differently across sponsors. Currently, there is no way to ensure that the rules regarding these updates are managed across the enterprise.

For example, Sponsor X may require that new users who have not taken the previous version must take the most up-to-date training when they start a clinical trial. Existing users who have taken the previous version are not required to update their training if the update is a minor change. When they go to their next study will they be required to take the updated training However, Sponsor Y may not require a user to re-train until the expiration date of their current training Each Sponsor may have different requirements about re-training

For the same Sponsor, X, a major change to a regulatory training module requires that all users, regardless of whether they have taken a previous version be required to update their training to the latest version at the time the version is released. For Sponsor X, even those who are already in a clinical trial, the requirement is to re-train at the time the new version of the regulatory training is released.

However, the rules regarding this may be different across sponsor; Sponsor Y sponsors may not require a re-training until the user starts their next trial.

What is needed is a system to manage version changes of regulatory training and update training plans for those users who are affected by the change based on a set of rules defined by the relevant sponsor or sponsors of clinical trials.

### BRIEF SUMMARY OF THE INVENTION

The invention provides a solution to at least all the abovementioned unmet needs. A system according to the invention manages version changes of regulatory training and update training plans for those users who are affected by the change based on a set of rules defined by the sponsor. The system also provides custom updated training plans where different sponsors have different rules affecting regulatory training updates.

It can be appreciated that any embodiment of a system implementing this invention will use a central processing unit, a memory device, data entry units, and reporting units, as are depicted in the figures accompanying this specification. All of the hardware elements of such a system, as well as the function of software, computer implementable instructions, are familiar to one of average skill in the relevant art.

The system allows a set of rules to be put into place for minor and major changes to regulatory modules. The rules can be as complex as required and include many different variables such as the type of update (minor or major), whether or not users who have been trained on a previous version must update their training for existing trials or only for new trials, the date on which the update comes into effect, trials which are excluded from the update, etc.

Regulatory training modules are designated as such in order to differentiate them from all of the other types of clinical trial training such as protocol specific training Version numbers are assigned to these modules and controlled in order to maintain the integrity of the system.

When a version change for a regulatory module is released by the sponsor, the system automatically applies the training rules to the release. The system evaluates the training profiles for all of the physicians and site support personnel who are currently involved in clinical trials. Physicians and site support personnel who join after the update is completed are also be affected by the rules that apply to the version change.

In one embodiment of the invention, the invention further provides an optimal training requirement satisfaction determination for any potential clinical trial staff, including but not limited to physicians. For any clinical trial, the optimal training schedule for a potential staff member, where such an optimal training schedule take into account the staff personal training record, requirements already satisfied, as well as the variety of training options available for remaining requirements yet to be satisfied. Such an optimized training schedule provides for accurate record of requirements already satisfied, thereby eliminating training redundancies. Moreover, such a system provides the most efficient satisfaction of any remaining training requirements, ensuring as rapid and efficient as possible staff qualification to participate in the clinical trial. Such an optimized and personalized training protocol further aids in the rapid commencement of site and personnel qualification, while maintaining auditable records for use by the trial Sponsor.

In one embodiment of the invention, the Sponsor can publish a list of training options and venues and allow the physician and site support staff to select the optimal training option based on their schedules and other commitments. Alternatively, the physician or staff can query the online training system to print out one's own training record, and an optimized potential training regimen from the training options available for to be satisfied training requirements. In this way, the invention provides a personalized, optimized training program for the clinical trial of interest.

### BRIEF DESCRIPTION OF THE DRAWINGS

Drawings to aid in the understanding of the invention are:

FIG. 1 is illustrative of a system for tracking online training according to the invention.

FIG. 2 illustrates an exemplar training profile according to the invention.

FIG. 3 illustrates an application of version change to Good Clinical Practice regulatory training module and depicts the application of a set of rules for re- training

### DETAILED DESCRIPTION OF A PREFERRED EMBODIMENT

It can be appreciated without the need for further elaboration, that a system according to the invention does necessarily include input and output devices connected to or networked with a main computer, where the main computer has at least one Central Processing Unit (CPU), a memory and storage module, processing capabilities, and instructions implementable by the computer (software or firmware) to perform all the functions described herein. The inventive method is comprised of steps using input devices for inputting data, storing data, processing data, and outputting data, where interaction with the system is generally accomplished via one or more graphical user interfaces.

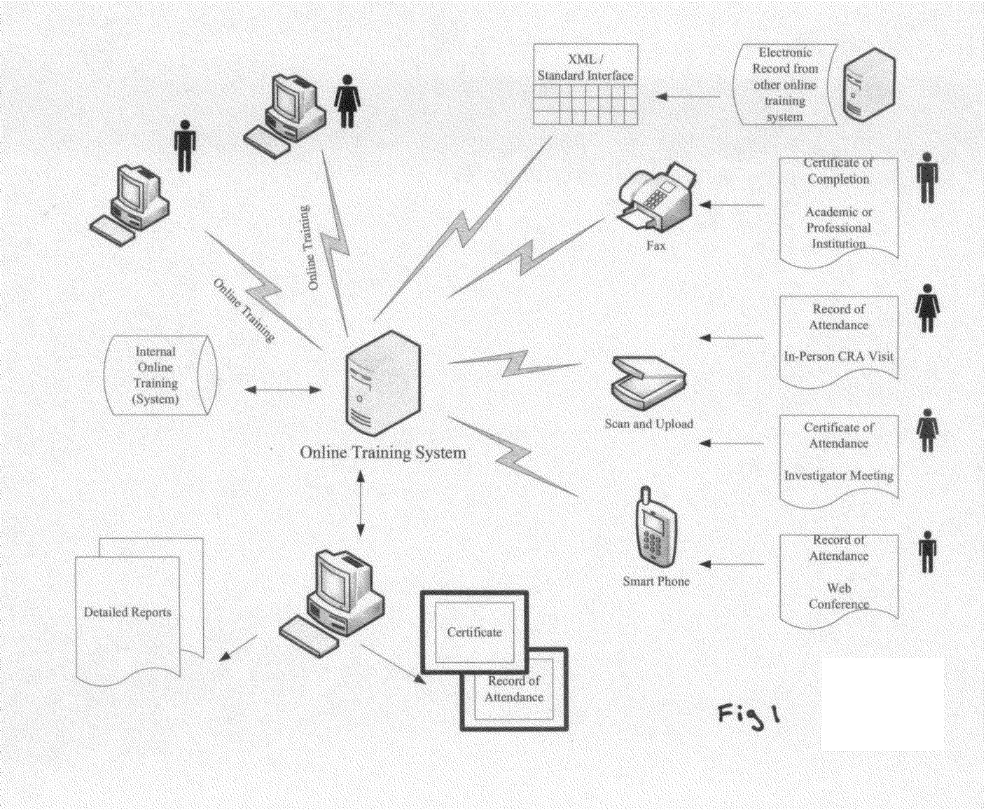

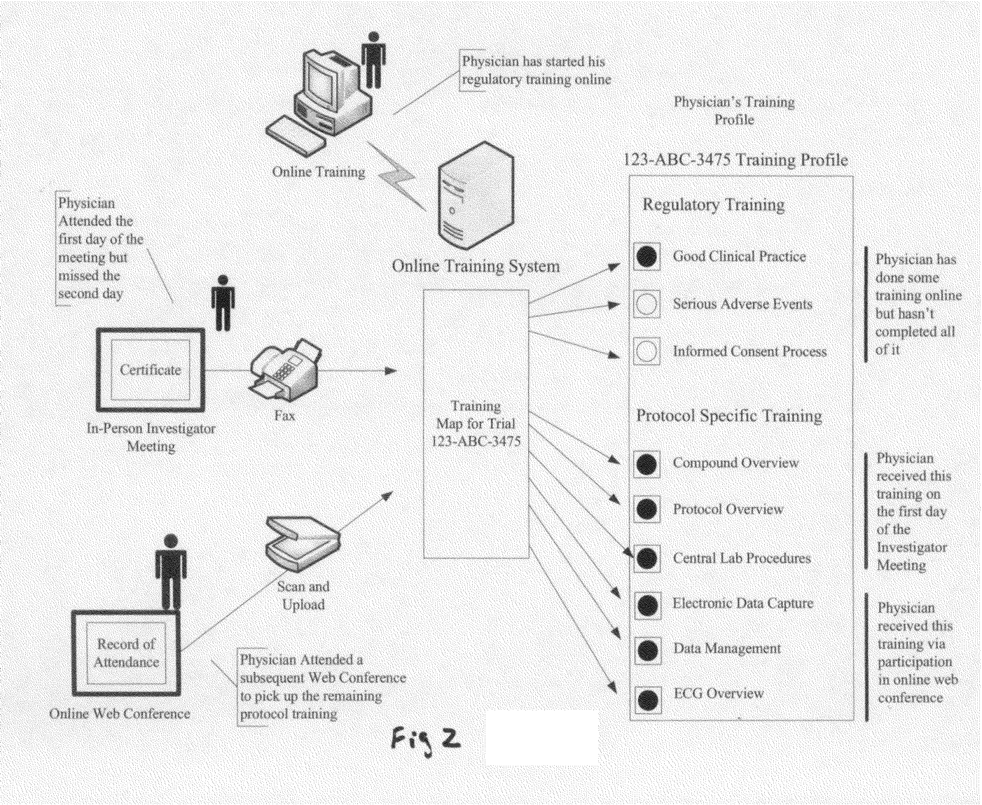

A person of average skill in the relevant art requires no special explanation to to comprehend how the invention works. Some generalized examples are depicted in the figures filed herewith, and discussed later herein. More discussion of the system depicted in FIGS. 1 and 2, appears in patent application entitled “Automated collection and aggregation of cross-platform and live event or in-person training records to support the conductance of clinical trials”, docket TRI007, filed Feb. 3, 2013, by inventors Alden Meier and Dave Young.

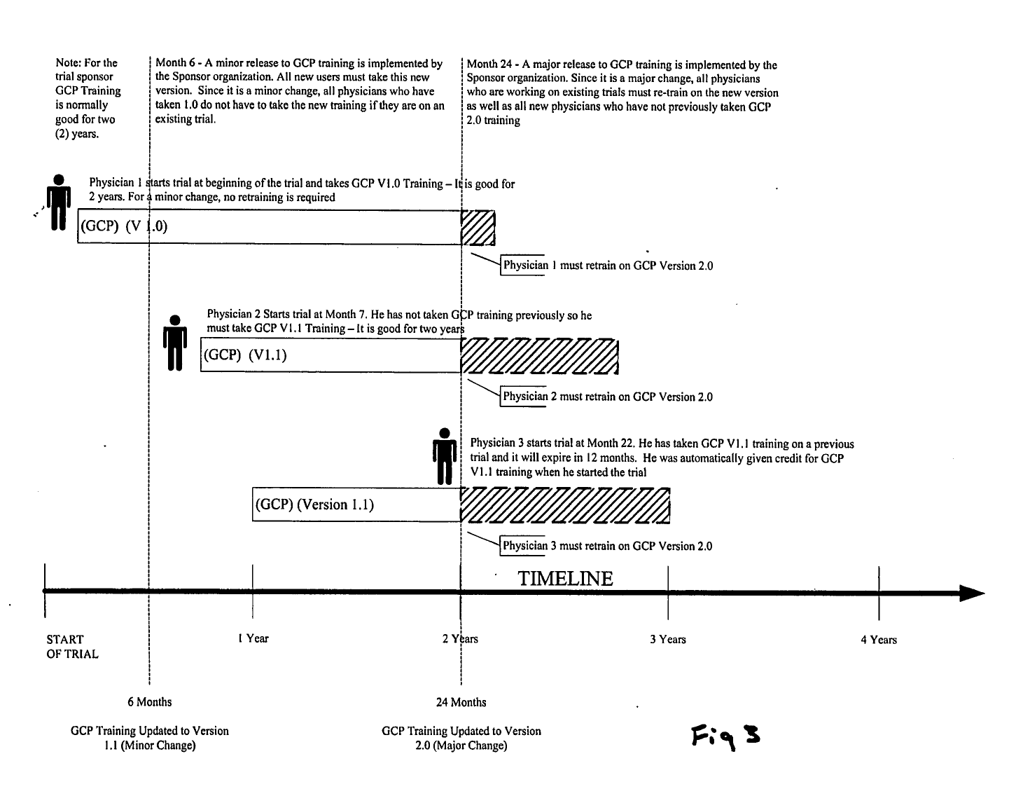

The below description can be understood along with reference to FIG. 3, and the reader can appreciate the utility of the invention taught herein. Although FIG. 3 depicts “physician” training, any clinical trial staff requiring training falls within the intended scope of the invention.

The discussion herein focuses on an example of the inventive utility.

### Example One

A clinical trial is initiated by a sponsor, whom we shall denominate “Sponsor X”. Sponsor X is using the current standard regulatory modules. One of the training modules, Good Clinical Practice (GCP) is currently at version 1.0 (in FIG. 3, (GCP) (V1.0). The duration for training on GCP is customarily two years-normally a physician need only re-train in GCP every 2 years (or 24 months).

GCP Version 1.1. Six months after the trial starts, a minor update to the GCP training is released and the new version is GCP V 1.1. Referring to the time line depicted in FIG. 3, it can be seen that at the left, “start of trial” and proceeding to the right, “6 months”, “1 year”, “2 years”, “3 years” and “4 years”. Referring to FIG. 3, on the bottom: At “6 months” GCP Training Updated to Version 1.1 (Minor Change); at the top: Month 6: A minor release to GCP is implemented by the Sponsor organization. All new users must take this version. Since it is a minor change, all physicians who have taken 1.0 do not have to that the new training is they are on an existing trial.”

Physician 1 (depicted in the upper left of FIG. 3) starts the trial at the beginning of the trial, and takes GCP V 1.0. It is good for 2 years, so for a minor change, no retraining is required.

Physician 2 starts the trial at month 7, and has not taken GCP previously, therefore physician 2 must train GCP V 1.1.

Sponsor X has determined that the rules for GCP will be as follows:
1. All users who have taken version 1.0 within the past two years do not need to take the 1.1 training for the remainder of any trials they are currently working on and will not be required to retrain on version 1.1 if they join a new trial within the two year period.
2. All new users who have not taken the GCP training within the past two years must take the 1.1 version before they can start working on the trial.

Sponsor X determines the release date for the change and the system automatically updates the training for all trials and makes version 1.1 the new requirement for all new participants on that date. Users who have started a trial and have taken training on version 1.0 are not required to retrain.

As depicted in FIG. 3, the rules apply to physician 1 and physician 2.

GCP Version 2.0. Two years into the same trial, Sponsor X releases a major change to the GCP training (GCP version 2.0) to address performance issues on their clinical trials. In this case, Sponsor X decides that all physicians and site support staff must take the new training, regardless of the version of their previous training or when they took it. Sponsor X again determines the release date for the change and the system automatically updates the training for all trials and makes version 2.0 the new requirement for all participants, including everyone who has trained on any previous version. All users have their training status updated and must complete the version 2.0 training in order to continue to work on the trial. The new training is good for two years before retraining is required.

Referring again to FIG. 3, the effect of GCP version 2.0 and the rules set by Sponsor X are depicted, illustrating how the effect plays out for the training requirements of physicians 1, physician 2, and an additional physician 3.

All three physician are required to retrain on GCP version 2.0, regardless of time since last training or version of last training on GCP.

It can be appreciated that the invention provides for proper tracking of minor versions, allowing for training credit to be applied and avoiding unnecessary re-training This was illustrated in the case of physician 1 in FIG. 3.

The invention further provides for organization wide implementation of changes by virtue of changing training status of all users according to rules set, and tracking compliance with the rules. As illustrated in FIG. 3, where significant changes are made (ex. GCP version 2.0), all physicians are required to re-train on GCP 2.0, and the invention provides for notice of the training requirement, as well as keeping record of compliance. For quality control in large clinical trials, such auditable tracking of training and compliance is essential.

It is to be understood that the invention can further reconcile rule differences between different sponsors with respect to regulatory training and cross-credit. Moreover, the invention provides, in one embodiment, an optimal training option to users. Thus, not only is the training status of Users tracked closely, the re-training requirements of the users are distilled into a “best fit” list of re-training options. Again, the implementation of such an output report, in light of the system components and functions as generally understood, needs no further explanation.

We claim:

1. An improved system for tracking and enforcing compliance and version control of regulatory training for clinical trials, in a networked system, said system comprised of at least one computing device, central processing unit, memory and storage, and computer implementable instructions for accomplishing data storage, maintenance and analysis, and input and output devices, said input and output devices connected to user interfaces, where said improvement comprises:
computer implementable instructions, said instructions expressing rules to manage version changes of regulatory training and
update training plans for those users who are affected by said version change of regulatory training; and
monitoring training status of all users, so that said clinical trial records of regulatory training compliance are comprehensive and accurate.

2. An improved method for tracking and enforcing compliance and version control of regulatory training for clinical trials, where said improvement comprises the steps of:
directing an online training system, where said system is comprised of at least one computing device, central processing unit, memory and storage, and computer implementable instructions for accomplishing data storage, maintenance and analysis, and input and output devices, said input and output devices connected to user interfaces, to apply rules regarding regulatory training to user profiles, where said user profiles are stored in memory and include user training status data, such that said system outputs an updated user training status.
